(19) United States
(12) Patent Application Publication
(10) Pub. No.: US 2014/0311039 A1
(43) Pub. Date: Oct. 23, 2014

(54) Garage door vent pivot unit

(71) Applicant: Aran Alton Ardaiz, Honolulu, HI (US)

(72) Inventor: Aran Alton Ardaiz, Honolulu, HI (US)

(21) Appl. No.: 13/986,331

(22) Filed: Apr. 22, 2013

(51) Int. Cl. E06B 7/02; E04B 1/72; E06B 7/20

(52) U.S. Cl. CPC E06B 7/02; E06B 7/20; E04B 1/72
USPC 49/470; 49/471

(57) ABSTRACT

The invention is a hands-free pivoting ventilation and restraint attachment to the base of an overhead sectional or solid garage door, door, or commercial door and is designed to permit screened air flow and light while impeding passage of debris, small animals, etc. in and/or out of the garage or room when the door is stopped approximately 0″-6″, as designed, from the floor to perform as described, yet deters human entry; and, upon closing the door, the unit pivots flat and out of the way and are designed to function in a garage door application without conflict with the standard automatic, self-opening laser eye “Auto Reverse” garage door operators currently in use.

### CROSS-REFERENCE TO RELATED APPLICATIONS

Not Applicable

### STATEMENT REGARDING FEDERAL SPONSORED RESEARCH OR DEVELOPMENT

Not Applicable

### REFERENCE TO SEQUENCE LISTING, ETC.

Not Applicable

### BACKGROUND OF THE INVENTION

Its need came about for restraint of a small Beagle and to keep the neighbor's cats from consistently entering the garage when the garage door was lifted approximately 6″ off of the floor to permit ventilation and light, and to not interfere with the electric-eye “Auto-reverse” safety device on garage doors. Another advantage of the invention is that it permits venting of combustible fumes from cleaning agents, gasoline etc. which are heavier than air odors. Air flow from the top of the door, when slightly opened, permits ingress of fresh air from above while permitting the heavier than air combustible odors to exit at the bottom through the netting of the invention. The invention's design is adaptable to doors over 24 feet, or more, in width and when fully assembled functions as a single, flexing, pivotal unit. This Inventor's invention falls into the Classification/Sub-classifications of 49/54; 160/113 and 454 for manual and electronically operated garage doors or vertical opening and closing doors of various kinds. The invention is designed to be totally hands free and is mounted to the bottom of a garage door or vertical opening door.

### BRIEF SUMMARY OF THE INVENTION

The invention is a less expensive, simple, small hand's free pivoting ventilation device which requires no maintenance after attachment to a vertical opening garage door or vertically opening and closing doors. The objective of the invention is to restrain small animals, debris etc. in or out of the garage or storage area while inhibiting access to persons, permit fresh air ventilation on hot days and to exhaust combustible heavier than air odors and gases. When the garage door is closed the invention pivots and lays flat on the floor. The invention is designed to not interfere with the “Automatic Reverse” safety device or electronic eye sensing device of electronic operated garage door openers, or on other vertical opening and closing doors.

### BRIEF DESCRIPTION OF THE SEVERAL VIEWS OF THE DRAWINGS

### Corresponding Statements

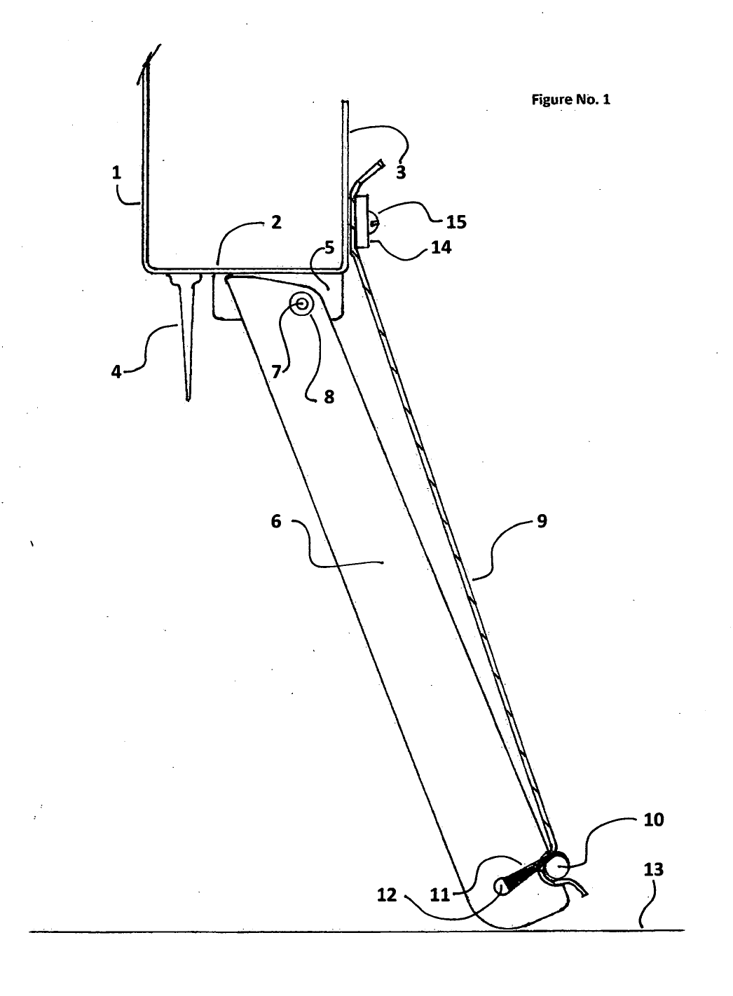

FIG. 1 shows the invention cross section from a left side angle, if facing to the exterior from inside the garage, showing the invention in the positioned open for use the Mounting Block (5), secured to the base of the garage door and the angle of the Pivot Arm (6), facing into the garage. The factory pre-assembled Pivot Unit pieces (5) and (6) are secured together with a mounting screw or pin (7) and flat washers (8) mounted on each side of (6) at the axis point of pivot. The pivoting of the (6) Pivot Arm when mounted by screw (7) to the Mounting Block (5) is set very loose so as to hang and freely rotate without restriction.

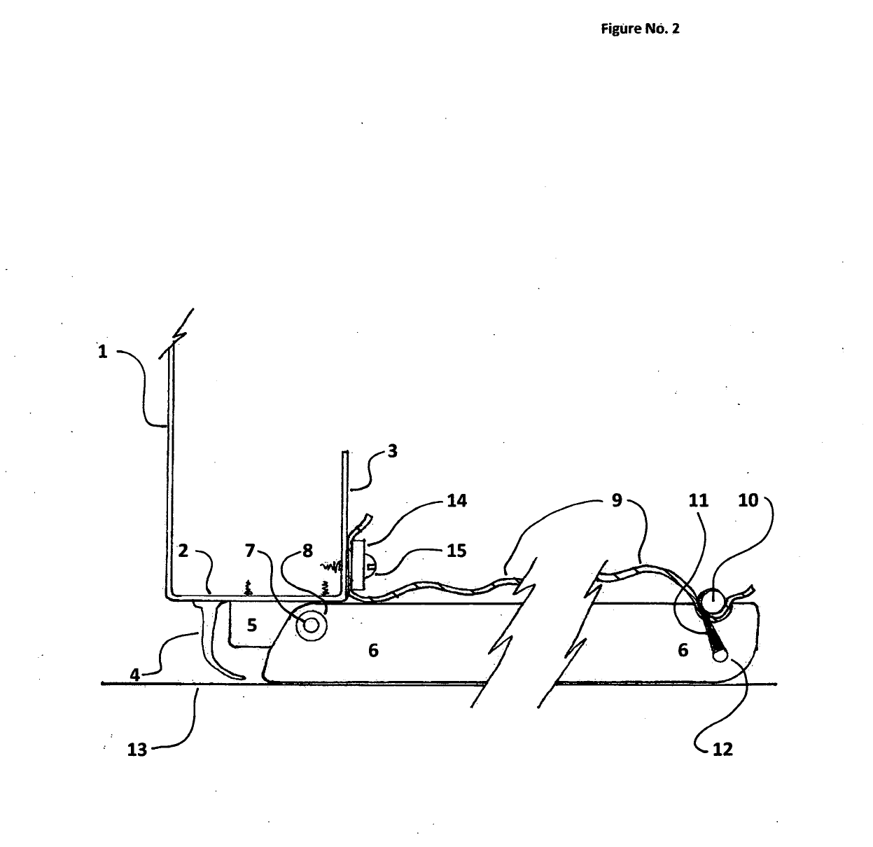

FIG. 2 is also a left angle cross-section assembled view of the invention in its rotated and flattened closed garage door position.

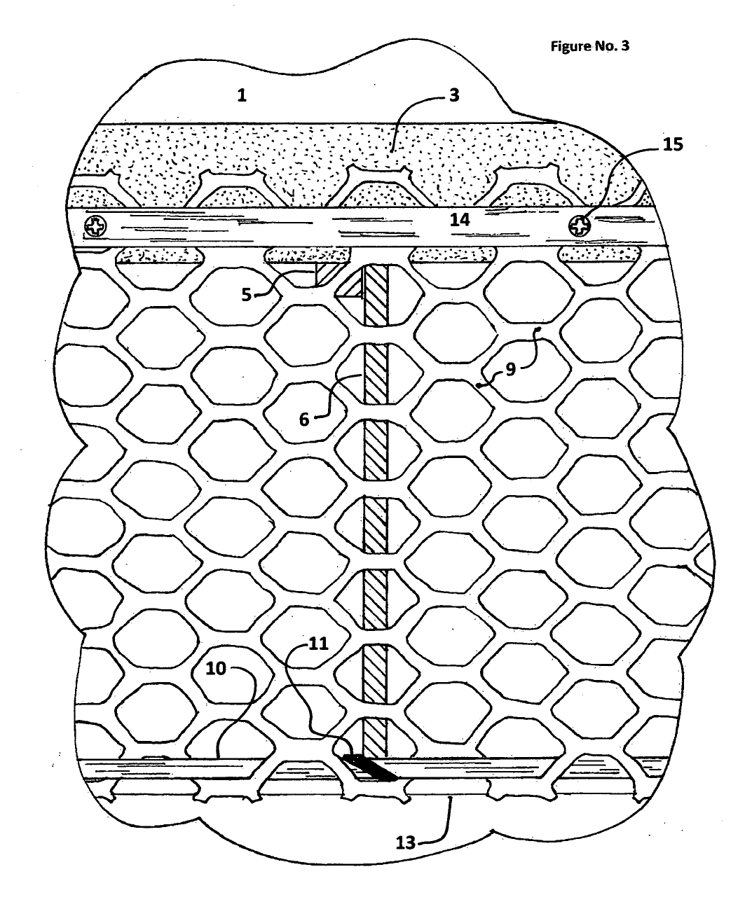

FIG. 3 is a partial interior garage door view of the unit in its typical, elevated garage door position.

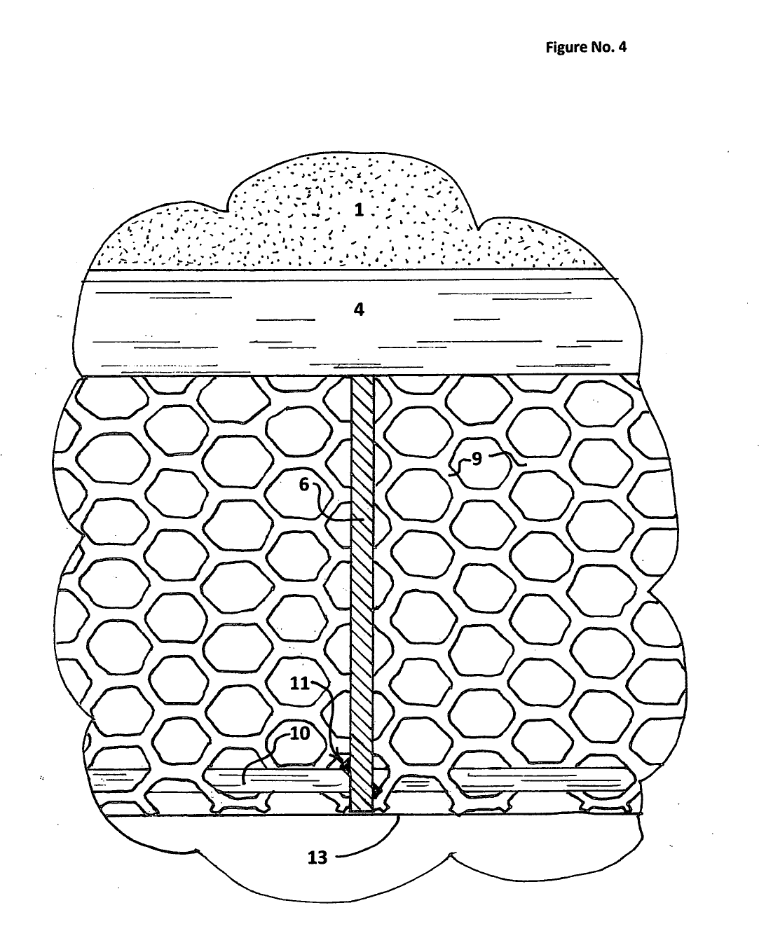

FIG. 4 is a partial exterior driveway elevated view of the invention showing the garage door bottom section.

NOTE: When the garage door is closed, there is no exterior evidence of the invention exposed. When the door is closed, the invention lays flat on the concrete floor extended toward the inside of the garage +/−6″ out from the door. The invention slides inside of and under the “Automatic Reverse” electronic eye beam when door is closing and closed.

### DETAILED DESCRIPTION OF THE INVENTION

The invention is uncomplicated and consists of a small fixed rectangular Mounting Block, which mounts on the bottom of the door. The Mounting Block and Pivot Arm are manufactured from plastic, metal or other hard substance. The Mounting Block is factory pre-attached with a screw of pin to the engineered angled Pivot Arm, which resembles an ice cream stick on its side and which attaches to either side of the Mounting Block. The invention includes and is then assembled with pre-cut vent webbing, mesh, wire screen, or netting; a pre-drilled Plastic Clamping Strip; and connecting tie rods. The major manufactured component is the Pivot Unit itself which consists of the Mounting Block and preset angled and beveled Pivot Ann, which when assembled with the attached ventilating webbing; Plastic Clamping Strip and rods, completes the invention.

Assembly to a vertical opening garage door or vertical opening commercial door is rather simple. Starting from the right and left edges of the door, the Pivot Unit locations are spaced approximately 24″ on center on the bottom of the door. The Mounting Block (5) and Pivot Arm (6) are factory assembled with the Mounting Blocks pre-drilled with two holes for hole gaging when mounting with sheet metal screws. Upon assembling, the extended angle of the Pivot Arm points into the garage or room. Once the Pivot Unit parts are in place, the webbing, screen, mesh or netting is secured to the inside vertical face of the garage door base lip with the pre-drilled Plastic Clamping Strip.

A small plastic pre-drilled Clamping Strip is used to evenly secure the vent webbing to the inside vertical lip face of the door base by drilling holes into the door lip and mounting same with sheet metal screws to affix the upper portion of the vent webbing to the door.

After securing the webbing to the door, a small hollow or solid rod (plastic, steel, nylon, aluminum or steel) is weaved evenly through the holes in the provided webbing at its bottom edge for the full width of the door. The several rod sections are attached using rubber surgical tubing to permit flexibility. After the rods are installed together and overall length cut to fit the inside face of the garage door, the rod, which has already been weaved into the webbing, is attached to each individually spaced Pivot Arm with a fiberglass Multi-Purpose Tie, or other means, using the pre-engineered hole in the beveled base of the Pivot Arm for that purpose.

Once the completed and assembled invention is mounted as described above, the “Auto-Reverse” electronic eye, door safety device, must be confirmed to be clear of the Pivot Arm's lower extension, when the door closes. The normal angle of the Pivot Unit's Pivot Arm is designed to clear most electronic laser eye-paths so as not to impede the closing action of the automatic garage door opener/closer. Should that be a concern, simply space-out (shim) the “Auto-Reverse” electronic eye mounts were they secure to the door frame on each side of the garage door to permit adequate clearance for the Pivot Units and “Auto-Reverse” protection system to function. Sometimes the automatic garage operator's door's sensitivity setting for the “Auto-Reverse” needs to be changed to permit full compression of the Pivot Device unit without auto-reversing, when closing.

The invention made from molding, extrusion and machining possesses the ability to be modified by creating larger Mounting Blocks (5), simple angle adjustments; application of rollers at the base of the Pivot Arms (6) and even longer Pivot Arms, if needed or desired, etc. The main Pivot Units can be manufactured out of plastic, aluminum, nylon, steel or other durable materials as may be required for the specific applications desired. The invention is basically a very simple invention that can take various forms and sizes to accomplish specific tasks; or to meet specialized commercial applications on a larger scale. The engineered Pivot Arm is secured to the small rectangular Mounting Block with two flat washers (8) and a mounting screw or pin (7) at its pivot axis point and together creates what the Inventor calls the “Pivot Unit”.

Unlike other inventions, the Pivot Unit fits on the bottom of the door (2) inside of the rubber weather seal (4) and the ventilation webbing (9) to the inside lip (3) of the door base (2). The Mounting Block (5) is secured with two sheet metal screws to the base of the door (2). The ventilation webbing, mesh or screen used for venting (9) is secured to the door base inside lip (3) with a pre-drilled plastic Clamping Strip (14) with sheet metal screws (15). The ventilation webbing is secured to the base of the Pivot Ann by a continuous, flexing rod system (10) which sets into a pre-cut opening. The rod sections are secured together with surgical tubing (16) which are then secured with Fiberglass Multi-purpose ties (16) or other appropriate means.

One of the inventions assembled characteristics with its ¼″+/− continuous and flexing rod (10), as spaced, is that it flexes slightly to conform to the minor contour variations of a typical concrete slab and finished floor.

Another immediate characteristic is that the Pivot Units opening size is restricted to inhibit, or as much as possible, deter human entry, or can be of a greater opening area by extending the Pivot Arm (6), if desired.

Another of the unique features of the invention is its engineered, variable, preset pivot angle which is designed for floor deflection to allow full and complete closing of the door without interfering with or halting the electronic protection and closing mechanisms of the garage door or door.

The invention is so simple as to not require any further extensive detailed descriptions. It is neither a locking nor an unlocking mechanism for a garage door, but a hands-free, flexible and folding ventilation, light, and deterrent as described above.

1. This ventilation and restraint invention made of plastic, metal or any other durable hard or semi-hard substance is designed to be utilized on either an electronic or manually operated overhead door or garage door, either sectional or solid, the Mounting Blocks and Pivot Arms which comprise the “Pivot Units” are set at spaced intervals by screwing the invention's rectangular Mounting Bases to the bottom plate of the door itself, the material used can determine the size of the invention which is comprised of;
the pre-drilled dual hole, rectangular Mounting Block to which a 7½+/−″ long, or longer, cambered Pivot Arm is set on edge, having a form similar to an ice cream stick, with its top end pre-engineered at with a camber to cause the Pivot Arm to hang at an deflection angle into the garage or room,
and, the Pivot Arm is affixed to the rectangular Mounting Block by a pivot pin or screw to allow for a totally free movement hanging at the pre-designed angle with or without floor contact rollers on the Pivot Arm's base,
and, the Pivot Arms are designed for door to floor compression impact and to carry flexible ventilation material of webbing, screen or netting, which is secured with rod sections and ties at its lower extremity,
and, with the ventilation material evenly stretched and secured full width to the inside vertical face of the door base by a pre-drilled, screwed in place, flat plastic strip-clamp,
and, with the Pivot Arms freely hanging, i.e. fully extended, the ventilating material is stretched evenly across the inside faces of the numerous Pivot Arms which are spaced at even intervals across the base of the door's full width,
and, the ventilation material and Pivot Arms are secured at the Pivot Arms lower extremity into a pre-cut notch with small plastic, metal or fiberglass rod sections joined together with rubber surgical tubing for flexibility, and then set into the pre-engineered, pre-molded notch uniformly securing the ventilation material,
and, when the ventilation material and rods are together secured with a tie through the pre-drilled hole at the base of each of the Pivot Arms there is created a uniform, attractive automatic minimal-flexing barrier, for ventilation.

2. The engineered “Pivot Unit” is the most crucial piece of the invention, and primary moving piece it being designed for repetitive floor impact with a rounded or roller base for deflection/sliding upon floor contact,
and, upon compression with the floor, the invention folds the flexible ventilation material on the Pivot Arms upper side while at the same time keeping the ventilation material secured with the rods and ties,
and, when the door is stopped short of closing and slightly elevated, the Pivot Arms hang down vertically giving an opening clearance of approximately six inches or more above the floor creating the barrier . . . affixed inside of the door's rubber weather stripping,
and, if the downward movement is not stopped prior to the door fully closing, the Pivot Arm when compressed by contact with the floor the rounded or roller bases of the Pivot Arms cause the full width of the invention to divert, deflect or slide inward as a single flexible unit,
and, as the door is dropped down to fully close or partially close, the invention's Pivot Arms fold the ventilation material upward as the Pivot Arms flatten with floor contact,
and, as mentioned, if the door continues to close, the Pivot Arms fold the ventilation material neatly above the Pivot Arms keeping the ventilation material off of the floor,
and, lying flat on the floor, the invention permits the door's standard or typical rubber weather seal to seal off outside elements at the typical below door floor contact area.

3. The invention's design permits ventilation, allows for venting heavier than air combustible fumes or odors through the inventions ventilation material base while drawing in fresh air from above the slightly opened door while also admitting light,
and, the invention constrains and/or restricts animals or human beings in or out by the simple method of allowing for the partial open setting of the garage door, or doors, to a pre-designated, desired height within the full range of the invention's Pivot Ann length,
and, the invention is designed to freely function in the free space between electronic eye beams and the doors so as to not interfere with the “Auto-Reverse” electronic safety eyes on automatic self-closing doors and garage doors,
and, the use of the invention does not require anything in the way of additional manual hand use to cause the invention to function except for the operator to electronically or manually place the door where desired, open, partially open or closed.
